(19) United States
(12) Patent Application Publication
(10) Pub. No.: US 2018/0026299 A1
(43) Pub. Date: Jan. 25, 2018

(54) Method of Manufacturing High-Density Solid Electrolyte Thin Film Using Room-Temperature High-Speed Powder Spray Method

(71) Applicant: Hyundai Motor Company, Seoul (KR)

(72) Inventors: Sam Ick SON, Suwon-si (KR); Eun Ji KWON, Gunpo-si (KR)

(73) Assignee: Hyundai Motor Company, Seoul (KR)

(21) Appl. No.: 15/377,247

(22) Filed: Dec. 13, 2016

(30) Foreign Application Priority Data
Jul. 21, 2016 (KR) 10-2016-0092865

(51) Int. Cl. H01M 10/0562; H01M 10/0525

(52) U.S. Cl. CPC H01M 10/0562; H01M 10/0525; H01M 2300/0071

(57) ABSTRACT

A method of manufacturing a high-density solid electrolyte thin film using a room-temperature high-speed powder spray method, nay include (a) preparing oxide-based solid electrolyte powder having an average particle size of 0.1 to 10 μm; (b) heat-treating the oxide-based solid electrolyte powder; and (c) forming an oxide-based solid electrolyte thin film by spraying the oxide-based solid electrolyte powder on an anode layer or a cathode layer by a room-temperature high-speed powder spray method.

### CROSS-REFERENCE TO RELATED APPLICATION

The present application claims priority to Korean Patent Application No. 10-2016-0092865 filed on Jul. 21, 2016, the entire contents of which is incorporated herein for all purposes by this reference.

### BACKGROUND

### Field of the Invention

Various embodiments of the present invention relates to a method of manufacturing a high-density solid electrolyte thin film using a room-temperature high-speed powder spray method, and more particularly, it relates to a method of manufacturing a solid electrolyte thin film that can form a high-density oxide-based solid electrolyte thin film by adjusting an average particle size of oxide-based solid electrolyte powder to 0.1 to 10 μm, heating the oxide-based solid electrolyte powder, and then spraying the oxide-based solid electrolyte powder under an optimized process condition by using a room-temperature high-speed powder spray method, largely improving ionic conductivity.

### Description of Related Art

An all-solid-state ion battery is considered an ultimate battery for safety as a battery which changes a flammable electrolyte of a lithium ion battery to an inorganic electrolyte. In the all-solid-state ion battery, the electrolyte is replaced with an inorganic solid electrolyte and thus there is no material degradation for durability, a change in characteristic according to a temperature is low, and cycle lifespan performance is excellent.

The all-solid-state ion battery is an important development subject to improve safety of the currently used lithium ion battery, ensure durability, and improve energy density. Particularly, a technique of thinning the solid electrolyte layer is a technique capable of improving weight energy of a battery unit and improving volume energy and various technical approaches have been attempted for implementing a high-density solid electrolyte film.

The solid electrolyte film needs to ensure high ionic conductivity as a unique characteristic of the material by minimizing defects in the film through high density and ensure high ionic conductivity by reducing a thickness of the electrolyte film.

The solid electrolyte material is largely divided into oxide-based materials and sulfide-based materials. The sulfide-based material is a ceramic material and has similar flexibility to metal, and thus when pressure is applied to a molded body, material deformation occurs similarly to soft metal, the solid electrolyte penetrates to upper and lower anodes or pores of the cathode layer, and the thickness of the solid electrolyte layer is reduced. Further, the thickness can be reduced by molding the sulfide-based solid electrolyte film alone and using a high-pressure presser.

A technique of most easily reducing the film thickness in the ceramic material is a method of reducing the thickness through processing after molding and sintering. The thickness may be reduced by using a precise cutter or reduced through surface polishing. In the case of mechanical processing, it is difficult to be processed with a thickness of 300 μm or less, and in the case of a polishing method, even through a chemical mechanical polishing (CMP) method used in a semiconductor process is applied, it is very difficult to be processed with a thickness of 20 μm or less. When an area of a specimen is increased, a lower processing thickness is further increased. In such a processing method, there are disadvantages that processing cost is expensive and a lot of lost articles are generated in the processing to increase a product price.

Particularly, in the case of the oxide-based solid electrolyte material, for densification, generally, a high-temperature sintering process is applied. While pores of the molded body are filled through movement of materials between particles in the sintering process, densification occurs. In the case of an oxide-based solid electrolyte garnet, a high-temperature process in which a sintering temperature is 1,100° C. or more is required. Further, the oxide-based solid electrolyte garnet has a mechanical characteristic of a typical ceramic material, and in the case of a material having such brittleness, breakage occurs before the material deformation occurs by mechanical force.

In techniques of densifying and thinning the oxide-based solid electrolyte, a top down method and a bottom up method are included. The top down method is a method of ensuring a high-density electrolyte as a thick sintering body and reducing a thickness through a post process and the bottom up method is a method of ensuring high density through a film forming process from a material forming step.

However, the top down method requires a sintering process for densification and a lot of loss is included in the processing step. Further, bottom up processes require high vacuum or have large constraints of a process condition for controlling a composition.

In order to densify and thin the oxide-based solid electrolyte, a thin film cannot be formed by a mechanical press such as conventional sulfide-based materials. Further, since the high-temperature process at a high temperature is required, there are many limitations due to manufacturing costs and processes.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a high-density oxide-based solid electrolyte thin film by adjusting an average particle size of oxide-based solid electrolyte powder to 0.1 to 10 μm, heating the oxide-based solid electrolyte powder, and then spraying the oxide-based solid electrolyte powder under an optimized process condition by using a room-temperature high-speed powder spray method such that ionic conductivity is largely improved, and completed the present invention accordingly.

Therefore, various aspects of the present invention are directed to providing a method of manufacturing a high-density solid electrolyte thin film with largely improved ionic conductivity using a room-temperature high-speed powder spray method.

In an aspect, various aspects of the present invention are directed to providing a method of manufacturing a high-density solid electrolyte thin film using a room-temperature high-speed powder spray method, the method including: (a) preparing oxide-based solid electrolyte powder having an average particle size of 0.1 to 10 μm; (b) heat-treating the oxide-based solid electrolyte powder; and (c) forming an oxide-based solid electrolyte thin film by spraying the oxide-based solid electrolyte powder on an anode layer or a cathode layer by the room-temperature high-speed powder spray method.

In the method of manufacturing the high-density solid electrolyte thin film using the room-temperature high-speed powder spray method according to an exemplary embodiment of the present invention, it is possible to form a high-density oxide-based solid electrolyte thin film by adjusting an average particle size of oxide-based solid electrolyte powder to 0.1 to 10 μm, heating the oxide-based solid electrolyte powder, and then spraying the oxide-based solid electrolyte powder under an optimized process condition by using a room-temperature high-speed powder spray method, largely improving ionic conductivity.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram schematically illustrating a process of forming an oxide-based solid electrolyte thin film using a room-temperature high-speed powder spray method according to an exemplary embodiment of the present invention;

FIG. 2 is an XRD graph of the oxide-based solid electrolyte thin film manufactured in an Example of the present invention and oxide-based solid electrolyte powder which is a raw material;

FIG. 3A and FIG. 3B are Raman analysis graphs of oxide-based solid electrolyte thin films manufactured in Comparative Example A and Example B of the present invention; and

FIG. 4A and FIG. 4B are graphs illustrating changes in impedance characteristic of oxide-based solid electrolyte thin films manufactured in Comparative Example A and Example B of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described in more detail as one exemplary embodiment.

The present invention includes using a high-speed powder spray method using a room temperature process for densification and thinning of an oxide-based solid electrolyte.

In techniques of densifying and thinning the oxide-based solid electrolyte, a top down method and a bottom up method are included. The top down method is a method of ensuring a high-density electrolyte as a thick sintering body and reducing a thickness through a post process and the bottom up method is a method of ensuring high density through a film forming process from a material forming step.

The top down method includes methods including mechanical processing (sawing) after sintering, chemical mechanical deposition after sintering, and the like. The bottom up method includes thin film deposition techniques using a vacuum process including physical vapor deposition and chemical vapor deposition, a technique of forming a coating film using sol-gel reaction, spray coating, pyrolysis coating, and the like.

The top down method requires a sintering process for densification and a lot of loss is included in the processing step. Further, bottom up processes require high vacuum or have large constraints of a process condition for controlling a composition.

Various aspects of the present invention are directed to providing a method of manufacturing a high-density solid electrolyte thin film using a room-temperature high-speed powder spray method including: (a) preparing oxide-based solid electrolyte powder having an average particle size of 0.1 to 10 μm; (b) heat-treating the oxide-based solid electrolyte powder; and (c) forming an oxide-based solid electrolyte thin film by spraying the oxide-based solid electrolyte powder on an anode layer or a cathode layer using the room-temperature high-speed powder spray method.

According to an exemplary embodiment of the present invention, the oxide-based solid electrolyte powder may use at least one selected from a group consisting of Li₇La₃Zr₂O₁₂, LiLaTiO₃, Li—Al—Ti—P—O and Li₃ZnGe₄O₁₆.

According to an exemplary embodiment of the present invention, in step (a), an average particle size of the oxide-based solid electrolyte powder may be adjusted to 0.1 to 10 μm by ball-milling for 1 to 5 minutes at 200 to 400 RPM. The oxide-based solid electrolyte powder is heavy with the density of 5.01 g/cm³ and thus a thin film state may be significantly affected by the size of the particles and process parameters. When the average particle size of the oxide-based solid electrolyte powder is less than 0.1 μm, a detachment rate is larger than a deposition rate and thus the film is not formed. When the average particle size is greater than 10 μm, a movement transfer amount at the time when the powder reaches an anode layer or cathode layer substrate is large to abrade the substrate. The average particle size of the oxide-based solid electrolyte powder may be 0.4 to 1 μm.

According to an exemplary embodiment of the present invention, in step (b), heat-treating may be performed for 4 to 6 hours at a temperature of 650 to 750° C. In detail, the heat treatment in step (b) may be performed for removing Li₂CO₃ formed on the surface of the oxide-based solid electrolyte powder. When the oxide-based solid electrolyte contacts CO₂ and H₂O in the air, Li₂CO₃ may be formed on the surface of the powder. When the Li₂CO₃ formed on the surface of the powder is present on a garnet surface as a material without ionic conductivity, the Li₂CO₃ acts as a resistive layer to be removed through heat treatment. In the instant case, when the heat treatment temperature is less than 650° C., the remaining Li₂CO₃ may be present, and when the heat treatment temperature is greater than 750° C., degradation of the raw powder may be caused.

According to an exemplary embodiment of the present invention, in step (c), when the oxide-based solid electrolyte powder is sprayed on the substrate together with high-speed transfer gas at a sonic speed level, the oxide-based solid electrolyte powder has conductivity and flexibility like metal at the time when ceramic powder contacts the substrate to form the film on the substrate. This process does not require a high vacuum and a high temperature and a composition of the powder and a composition of the thin film have very high consistency.

An apparatus for implementing such a technique includes a powder supply device, a transfer gas supply device, and a deposition chamber. The powder supply device floats the powder to transfer the floated powder to a transfer pipe and spray the transferred powder to the substrate through a nozzle in the deposition chamber together with high-speed transfer gas. In the instant case, chemical characteristics (ionic conductivity and the like) of the thin film may be determined according to parameters including density, a size, and a shape of the powder, a velocity of transfer gas, a powder content, a structure of a nozzle, a distance between a nozzle and a substrate, and the like.

In step (c) above, the room-temperature high-speed powder spray method may be performed under a condition in which a substrate transfer speed is 100 to 400 mm/min, a transfer distance between the substrate and the nozzle is 25 to 45 mm, and a nozzle width is 30 to 40 mm. In detail, as the process condition of the room-temperature high-speed powder spray method, when the substrate transfer speed is less than 100 mm/min, it is not easy to control a film thickness and when the substrate transfer speed is greater than 400 mm/min, it is difficult to form a dense film. Further, when the transfer distance between the substrate and the nozzle is less than 25 mm, a substrate damage and a nozzle damage may occur, and when the transfer distance is greater than 45 mm, it is difficult to efficiently transfer the powder. In addition, the room-temperature high-speed powder spray method may be performed under a condition in which the number of repeated times is 1 to 3 and an average powder consumption amount per substrate is 1 to 5 g.

According to an exemplary embodiment of the present invention, in step (c), in the room-temperature high-speed powder spray method, N₂ is injected as transfer gas and a gas flow rate of N₂ may be 30 to 40 l/min. Like the present invention, in the case where the oxide-based solid electrolyte is deposited by the room-temperature high-speed powder spray method, when compressed air is used as the transfer gas while the deposition chamber is maintained at a low vacuum, even though moisture is managed at 100 ppm or less, while the powder is finely ground in the substrate, a surface having a high activity is largely exposed and then a large amount of Li₂CO₃ may be formed on the substrate.

When the formed Li₂CO₃ is present on the garnet surface as a material without ionic conductivity, the Li₂CO₃ acts as a resistive layer. Generally, pyrolysis occurs from 400° C. or more to remove the Li₂CO₃ through heat treatment after forming the thin film. However, an additional process is required and a substrate limit and an additional reaction according to heat treatment may be present, N₂ is injected as the transfer gas.

Further, a gas flow rate of N₂ may be in a range of 30 to 40 l/min under the current condition, and when the gas flow rate is less than 30 l/min, the powder supply may be insufficient and when the gas flow rate is greater than 40 l/min, the powder supply may be exceeded. The process may be performed under a gas flow rate condition of 35 l/min. The gas flow rate may be changed according to a nozzle width and a transfer speed.

The solid electrolyte thin film may be thin to maintain electric insulation, and according to an exemplary embodiment of the present invention, the thickness of the oxide-based solid electrolyte thin film formed in step (c) may be 1 to 200 μm. When the thickness of the oxide-based solid electrolyte thin film formed through the room-temperature high-speed powder spray method is less than 1 μm, electrical short circuit may occur, and when the thickness is greater than 200 μm, a conductance characteristic which is important as an electrolytic film may deteriorate.

According to an exemplary embodiment of the present invention, ionic conductivity of the oxide-based solid electrolyte thin film formed in step (c) may be 1×10⁻⁷ to 3×10⁻⁷ S/cm. The ionic conductivity may be 2×10⁻⁷ to 2.5×10⁻⁷ S/cm. The ionic conductivity may be 2.27×10⁻⁷ S/cm.

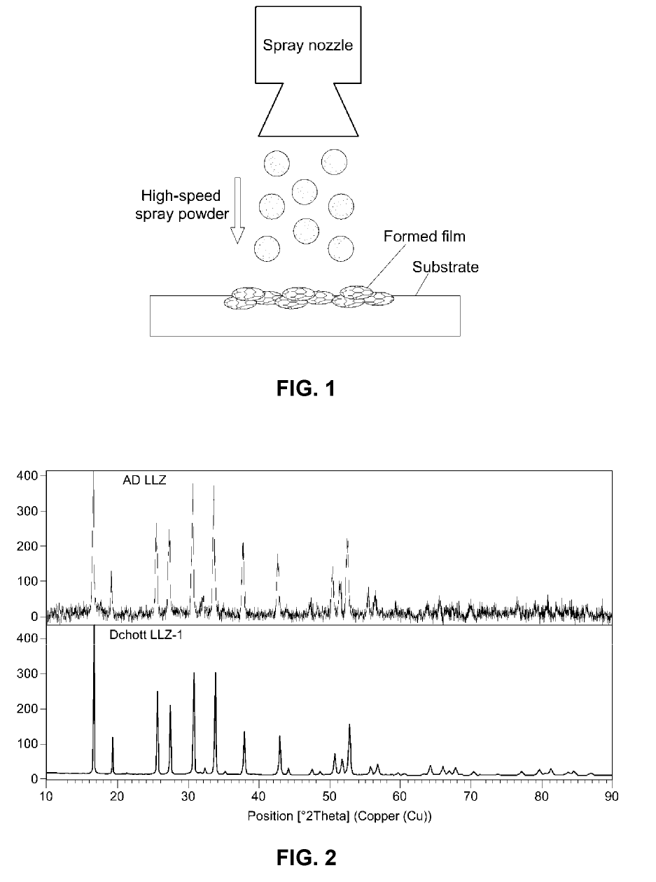

FIG. 1 is a schematic diagram schematically illustrating a process of forming the oxide-based solid electrolyte thin film by the room-temperature high-speed powder spray method according to an exemplary embodiment of the present invention.

Accordingly, in the method of manufacturing the solid electrolyte thin film of the present invention, the oxide-based solid electrolyte powder is adjusted to have an average particle size of 0.1 to 10 μm, is heat-treated, and then is sprayed under an optimized process condition by using the room-temperature high-speed powder spray method to form a high-density oxide-based solid electrolyte thin film and largely improve ionic conductivity.

Hereinafter, the present invention will be described in more detail based on Examples and the present invention is not limited by the following Examples.

### EXAMPLES

### Example

LLZ solid electrolyte powder having an average particle size of 0.4 to 1 μm was prepared in a reactor by ball milling for 3 minutes at 300 RPM. Thereafter, the LLZ solid electrolyte powder was heat-treated for 5 hours at a temperature of 700° C. Then, the LLZ solid electrolyte powder was sprayed on a cathode layer by the room-temperature high-speed powder spray method to form a LLZ solid electrolyte thin film with a thickness of 16 μm. In the instant case, the room-temperature high-speed powder spray method may be performed under process conditions of injecting N₂ as transfer gas, a nozzle width of 35 mm, stand-off of 10 mm, a compressed air flow rate of 35 l/min, a substrate transfer velocity of 300 mm/min, the number of repeated times of 2, and a transfer distance of 35 mm.

### Comparative Example

Except for using compressed air as the transfer gas in the room-temperature high-speed powder spray method, a LLZ solid electrolyte thin film was formed by the same method as the Example.

### TEST EXAMPLES

### Test Example 1

To confirm phases of the LLZ solid electrolyte thin film manufactured in Example above and the LLZ solid electrolyte powder, X-ray diffraction (XRD) was measured and the result thereof was illustrated in FIG. 2.

FIG. 2 is an XRD graph of the oxide-based solid electrolyte thin film (upper side) manufactured in Example and the oxide-based solid electrolyte powder (lower side) which is raw powder. As confirmed in FIG. 2, it can be seen that phases of the oxide-based solid electrolyte thin film formed in Example and the solid electrolyte powder coincide with each other. As a result, it can be seen that while there is no phase change in the processes of the high-speed powder spray method and the phase of the raw powder is maintained, the film is formed.

### Test Example 2

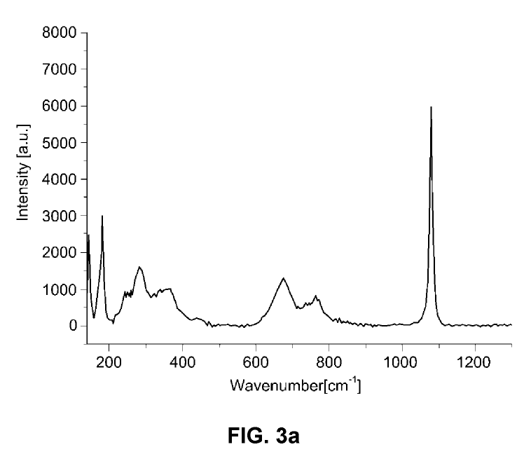

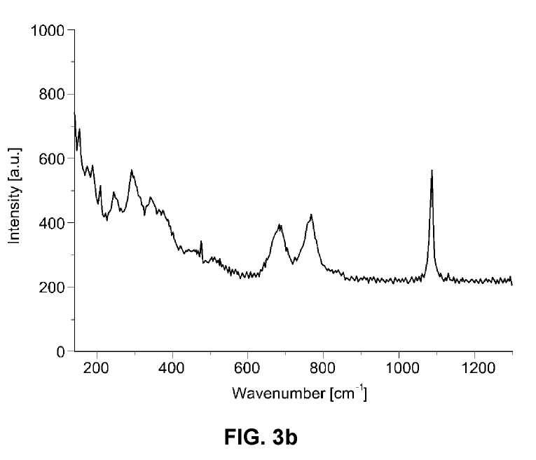

With respect to the LLZ solid electrolyte thin film manufactured in Example and Comparative Example, to confirm whether impurities of Li₂CO₃ are formed, the LLZ solid electrolyte thin film was measured by Raman analysis. The result was illustrated in FIG. 3. Herein, through the Raman analysis, when Li₂CO₃ is formed on the surface of the LLZ solid electrolyte thin film, a peak is detected in a wavelength area of 1100 cm⁻¹.

FIG. 3 is a Raman analysis graph of the oxide-based solid electrolyte thin film manufactured in Comparative Example (a) and Example (b). In FIG. 3A, it can be confirmed that the peak is largely detected in the wavelength area of 1100 cm⁻¹. On the contrary, in FIG. 3B, the peak is detected to be relatively low. As a result, in the case of injecting N₂ instead of the compressed air as the transfer gas in the process condition of the room-temperature high-speed powder spray method, it can be seen that the formation of Li₂CO₃ is largely suppressed.

### Test Example 3

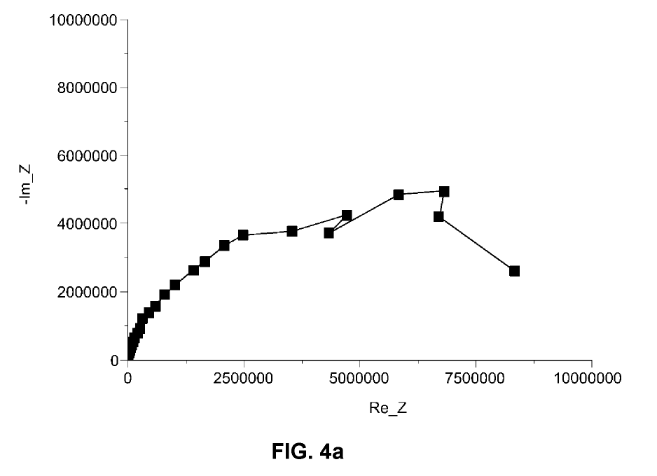

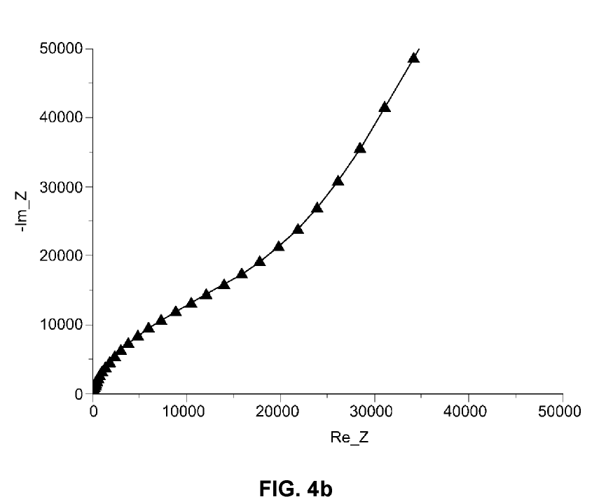

To measure ionic conductivity of the LLZ solid electrolyte thin film manufactured in Example and Comparative Example, an upper electrode was formed by Au deposition and an impedance analysis was performed. The result was illustrated in FIG. 4.

FIG. 4 is a graph illustrating changes in impedance characteristic of the oxide-based solid electrolyte thin films manufactured in Comparative Example (a) and Example (b). As confirmed in FIG. 4, it is shown that the ionic conductivity significantly increased. Further, it was confirmed that the ionic conductivity in the Comparative Example was 7.23×10⁻¹⁰ S/cm, but the ionic conductivity in the Example was 2.27×10⁻⁷ S/cm.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of manufacturing a high-density solid electrolyte thin film using a room-temperature high-speed powder spray method, the method comprising:
(a) preparing oxide-based solid electrolyte powder having an average particle size of 0.1 to 10 μm;
(b) heat-treating the oxide-based solid electrolyte powder; and
(c) forming an oxide-based solid electrolyte thin film by spraying the oxide-based solid electrolyte powder on an anode layer or a cathode layer by the room-temperature high-speed powder spray method.

2. The method of claim 1, wherein in the step (a), ball milling is performed for 1 to 5 minutes at 200 to 400 RPM.

3. The method of claim 1, wherein in the step (b), heat-treating is performed for 4 to 6 hours at a temperature of 650 to 750° C.

4. The method of claim 1, wherein in the step (c), the room-temperature high-speed powder spray method is performed under conditions in which a substrate transfer speed is 100 to 400 mm/min, a transfer distance between a substrate and a nozzle is 25 to 45 mm, and a width of the nozzle is 30 to 40 mm.

5. The method of claim 1, wherein in the step (c), in the room-temperature high-speed powder spray method, N₂ is injected as a transfer gas and a gas flow rate of the N₂ is 30 to 40 l/min.

6. The method of claim 1, wherein a thickness of the oxide-based solid electrolyte thin film formed in the step (c) is 1 to 200 μm.

7. The method of claim 1, wherein ionic conductivity of the oxide-based solid electrolyte thin film formed in the step (c) is 1×10⁻⁷ to 3×10⁻⁷ S/cm.
